(19) United States
(12) Patent Application Publication
(10) Pub. No.: US 2010/0146009 A1
(43) Pub. Date: Jun. 10, 2010

(54) Method of DJ commentary analysis for indexing and search

(75) Inventors: Kunal Kandekar, Morrisville, NC (US); Greg Evans, Raleigh, NC (US); Alfredo Issa, Apex, NC (US)

Correspondence Address: AKERMAN SENTERFITT, 8100 BOONE BOULEVARD, SUITE 700, VIENNA, VA, 22182-2683, US

(73) Assignee: Concert Technology, Durham, NC (US)

(21) Appl. No.: 12/314,193

(22) Filed: Dec. 5, 2008

(51) Int. Cl. G06F 17/30; G06F 7/00

(52) U.S. Cl. 707/803; 707/E17.014

(57) ABSTRACT

A method of conducting a disc jockey (DJ) commentary analysis for indexing and search is provided. More specifically, a method is provided for automatically generating metadata related to commentary of media segments to enable tagging, storing and context relevant searching. Speech-to-text conversion technology and audio/video analysis are used to generate content and metadata. Subject matter is then identified and filtered to a predetermined set of subjects. Metadata tags and context profiles for the media segments are generated to index the media segments. Moreover, context information of the user is used to generate a context profile of the user in a format similar to that of the media segment. Indexed media segments are searched to match with the user context profile and a relevant media segment is presented to the user.

### FIELD OF THE INVENTION

The present application relates to a method of conducting a DJ commentary analysis for indexing and search.

### BACKGROUND OF THE INVENTION

Just-in-time (JIT) disc jockey (DJ) snippet services such as vendor-branded Internet radio, JIT near-live DJ for Internet radio and on-demand DJ service for personal media players benefit from having contextual information and metadata to provide relevant media snippets or segments to listeners.

However, a method is needed whereby such information is automatically extracted so that the large volume of DJ commentary produced by broadcast radio stations or other sources can be tagged, stored, and searched.

### SUMMARY OF THE INVENTION

According to one aspect, a method consistent with the present invention provides for automatically generating metadata related to commentary of media segments to enable tagging, storing and context relevant searching. Speech-to-text conversion technology and audio/video analysis are used to generate content and metadata. Subject matter is then identified and filtered to a predetermined set of subjects. Metadata tags and context profiles for the media segments are generated to index the media segments.

According to another aspect of the present invention, context information of the user is used to generate a context profile of the user in a format similar to that of the media segment. Indexed commentary media segments are searched to match with the user context profile and a relevant commentary media segment is presented to the user.

Thus, the present invention provides a method of generating metadata for disc jockey (DJ) commentary media segments to enable contextually relevant searches, the method comprising: generating data including using at least one of speech-to-text conversion or audio/video analysis; analyzing the generated data to extract subject matters; filtering the extracted subject matters such that they only refer to a pre-determined set of subjects; accepting any other contextual information; generating metadata tags for each of the media segments using the predetermined set of subjects referenced during the filtering step; generating a context profile for each media segment using the metadata tags and the other contextual information; and indexing the media segments using at least one of the metadata tags or the context profile.

The predetermined set of subjects of the filtering step includes at least one of: media content, artist or category, events and conditions, time, location, or opinions.

The method of the present invention may further comprise: receiving user context information, including time, location and interests; building a context profile from the received user context information in the same format as the metadata tag generating step; finding one or more commentary media segments by searching the index constructed by the metadata tag generating step using a profile of the extracted subject matters of the analyzing step; and identifying a most relevant commentary media segment by determining that the most relevant commentary media segment's profile most matches the profile of the analyzing step.

The present invention also contemplates a system and a computer readable medium comprising a program for instructing the system to perform the above-described operations.

There has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a system diagram for a just-in-time near live DJ service for which the method according to an exemplary embodiment of the present invention is applicable;

FIG. 2 is a block diagram illustrating a media snippet or segment creation function;

FIGS. 3A and 3B together show a flow chart that illustrates the operation of the method according to an exemplary embodiment of the present invention;

FIG. 4 shows a flow chart that illustrates the operation of the media snippet or segment search; and

FIG. 5 shows a more detailed view of the DJ snippet and ad server 30 of FIG. 1.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

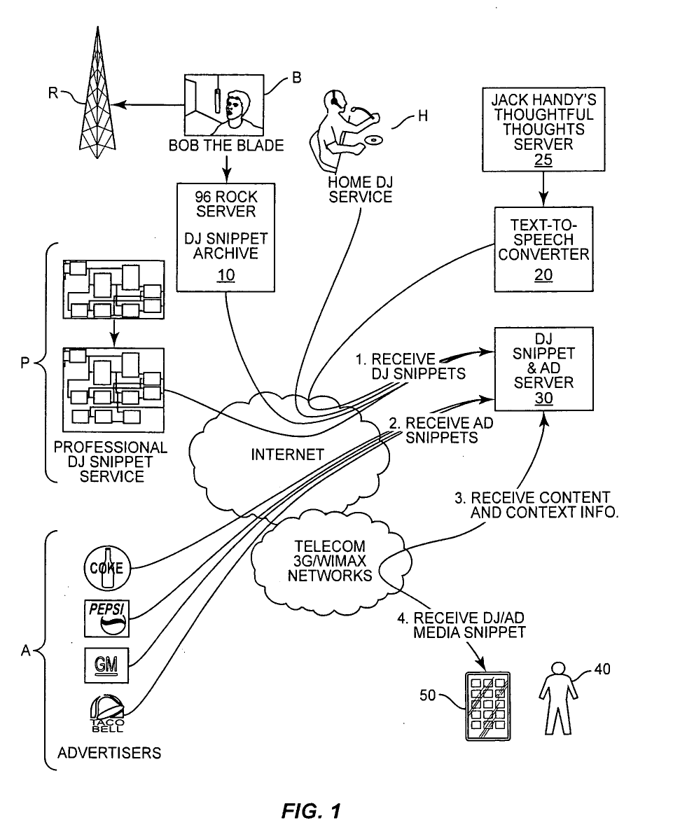

FIG. 1 illustrates a system diagram for a just-in-time near live DJ service for which the method according to an exemplary embodiment of the present invention is applicable.

More specifically, DJ commentary is composed of audio snippets gathered from a number of sources, such as a specialized snippet providing service, audio archives of actual satellite and terrestrial radio stations, user-generated comments, text-to-speech of online textual commentary, etc.

With reference to FIG. 1, a DJ “Bob the Blade” denoted by B provides commentary over the airwaves during, for example, a live radio broadcast from antenna R. The comments are stored in a server/DJ snippet archive 10. Comments from an at-home DJ service denoted by H may also be provided and stored as snippets. Input from a professional DJ snippet service P may also be provided. Moreover, input from various advertisers A is likewise provided in the form of snippets. A text-to-speech converter 20 connected to a server 25 may also be provided as a source of input. All of the various inputs noted above are provided, for example, over the Internet to a DJ snippet and advertisement server 30. A user 40 having a mobile device 50, including smart phones such as but not limited to an iPhone®, may access the DJ snippet and advertisement server 30 over the Internet through, for example but not limited to, a telecom 3G/WiMax Network. The user-40 may also send user generated comments as input to the snippet server 30.

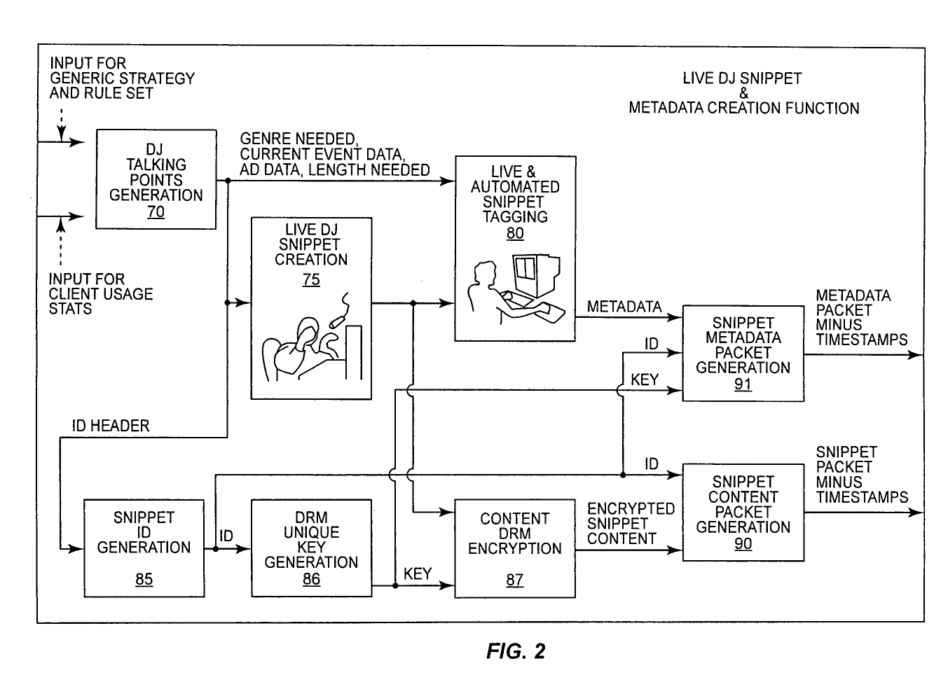

With reference to FIG. 2, the audio snippet content and metadata creation may be either a separate process, or may be extracted from DJ commentary generated during a live radio broadcast as at 75. For example, if the snippets are specially created for JIT-binding, a given DJ receives talking points as at 70 or other information related to a music genre, current events, etc. Target segment lengths are given to the DJs as well. Identification headers represent a given DJ and pre-tag the initial snippet. Each snippet generated goes to a more detailed tagging function that may be live, automated, or a combination of both as at 80. In other words, keywords may be directly generated in a speech-to-text function, while more complex tagging would be done by a music expert.

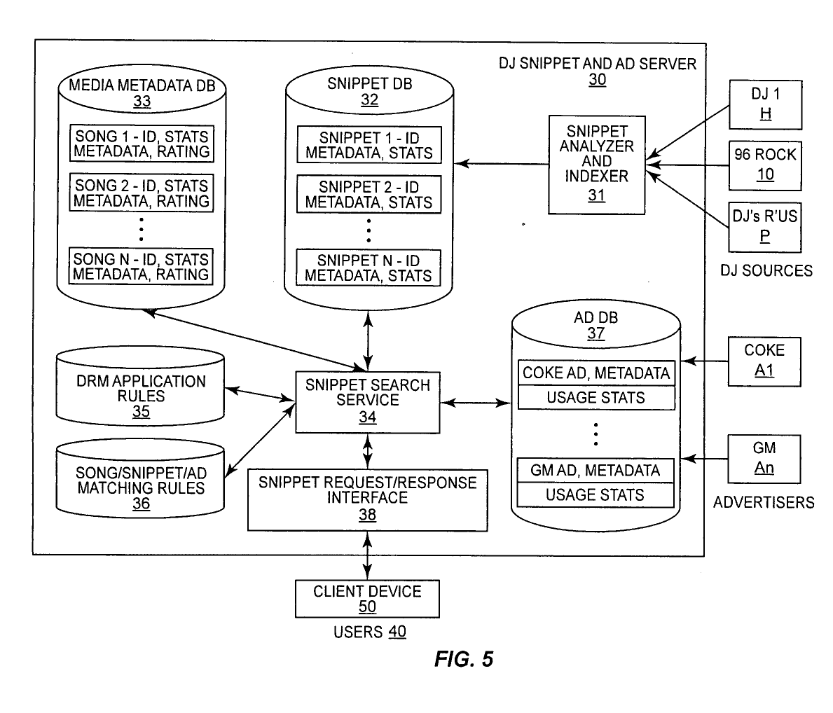

In parallel to the tagging functions, unique identification (ID) 85 and (optionally) digital rights management (DRM) encryption keys 86 are generated for each snippet. As content is sent for tagging, it is also encrypted to the key as at 87. Finally, the snippet ID, key, and encrypted content are sent to a content packet generation function 90 and output to, for example, a holding buffer (not shown). Likewise, metadata, IDs, and keys are sent to a metadata packet generation function 91 and output to, for example, a repository (discussed in more detail below with respect to FIG. 5).

The method of the present invention is related to providing server-side enablement for metadata and context extraction for DJ-provided commentary snippets as discussed above to enable indexing and search for Just-in-time (JIT) near live DJ for internet and search, JIT near live DJ for internet radio, and Protected Distribution and location based aggregation service. It is comparable to a Google-like search service, except that the method according to the present invention accepts textual as well as speech data and extracts only those keywords that are highly relevant for media commentary search. Since only those keywords are indexed, searches for snippets using those keywords, are fast and accurate.

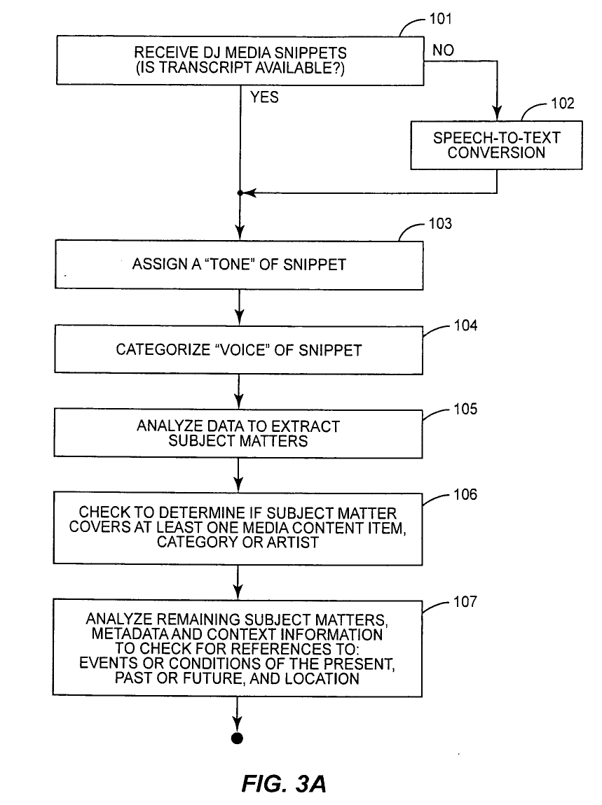

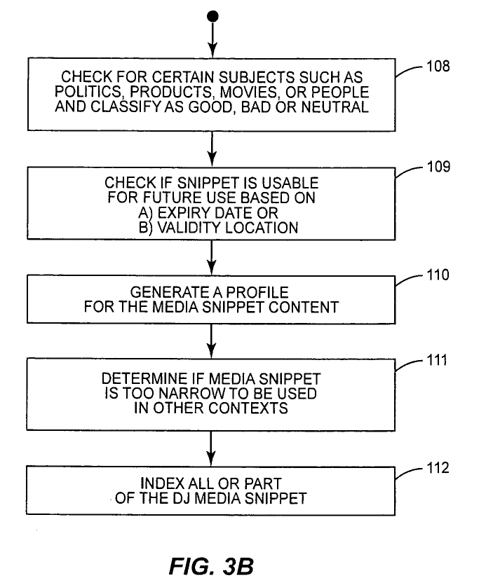

With reference to the flow diagram of FIGS. 3A and 3B, the method of the present invention generates relevant context metadata for DJ commentary media snippets or segments.

More specifically, in step 101, the method receives DJ media snippets, along with any transcripts, identification data, content metadata and context information (such as the DJ's current location, current data and time, etc.). Depending on the source of the snippet, the transcript may be automatically available, or the snippet itself may originally be in text form (for example, if the source is textual commentary such as text-to-speech converter or server 20 in FIG. 1). In this case, the text-to-speech does not have to be converted back to text as the original text itself is directly accessible.

In step 102, if transcripts are not available, speech-to-text conversion is performed on the media snippet, and also extracts any metadata from context and/or audio and/or video components of the snippet.

In step 103, techniques such as voice recognition and laughter detection are used to assign a “tone”.

In step 104, voice classification techniques are used to categorize the voice of the snippet, e.g., “gruff”, “soft”, etc.

In step 105, the data from steps 102-104 are analyzed, to extract subject matters, using: semantic analysis, keyword analysis, natural language processing, and other techniques known in the art.

In step 106, the method checks to determine if at least one of the subject matter covers at least one media content item, category or artist. It can even check references to such things using semantic analysis and an ontology.

In step 107, the method analyzes the remaining subject matters as well as the metadata and context information of step 101 to check for references to: events or conditions (“weather”, “traffic”, “rain”, “concert”), of: i) the present (look for keywords “today”, “now”, “right now” etc.), ii) the past (look for keywords “yesterday”, “last week”, “last year” etc.), iii) (anticipated) of the future (look for keywords “tomorrow”, “now”, “right now”), iv) a location (look for geographical keywords like “Raleigh”, “1-40”, “downtown” etc.).

In step 108, the method checks for references to certain subjects, such as politics, products, movies, or people, and classifies these remarks as good, bad or neutral, if possible.

In step 109, the method checks if the snippet is usable for future use by checking if, for example, it makes references to: a) events or conditions of the present, past or future (from step 107) that will not apply beyond a certain specified date, b) events or conditions of a location (from step 107) that will not apply to other locations.

In step 110, a profile is generated for the media snippet content, which could be an Extensible Markup Language (XML) or other indexable data structure describing the subject matters of the snippet and their contexts. The profile is built using information from steps 107-109, comprising: a) metadata about media content, category or artist from step 107, b) an “expiry date” if step 109a applies, c) “validity location” date if step 109b applies, d) other relevant metadata.

In step 111, it is determined if the snippet is too narrow in context to be used in other contexts using: a) heuristics, b) keyword filtering using pre-configured keywords (for instance, references to local celebrities), c) pre-configured rules that operate on the extracted metadata (for example, the snippet 20 talks about traffic at a given date and location), d) other inference techniques known in the art.

In step 112, all or part of the media snippet and the information of step 101 is indexed using the keywords or metadata in the profile of step 110 and then stored in a repository such as snippet database 32 as described in more detail below with respect to FIG. 5.

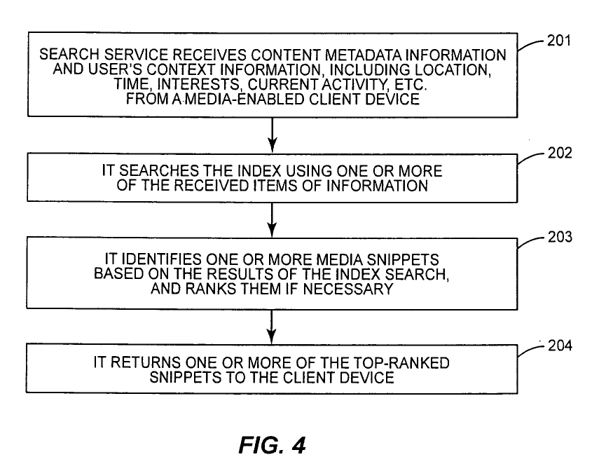

Referring to FIG. 4 which shows the snippet search operation, the snippet search service receives metadata information about media content being played on personal media player and use context.

It receives the user's context information, which includes: a) location, b) time, c) interests and preferences, d) current activity, e) mood, etc. (see step 201).

In step 202, the service searches the index using one or more of the received items of information.

It identifies one or more media snippets based on the results of the index search, and ranks them if necessary (step 203).

It forwards the identified snippet (or one or more of the top ranked snippets) to the personal media player or client device (step 204).

FIG. 5 shows a more detailed view of the DJ snippet and ad server 30 FIG. 1. More specifically, the DJ snippet and ad server 30 includes a snippet analyzer and indexer 31 which performs the various steps discussed in detail above with respect to FIGS. 3A and 3B. The snippet analyzer and indexer 31 receives DJ snippets in various formats (e.g., audio, video, text) from various sources such as those depicted in FIG. 2. The snippet analyzer and indexer 31 then semantically analyzes the DJ snippets for media-relevant content, after performing speech-to-text, if necessary, and checks against a media metadata database 33 (again the steps of which are depicted in detail in FIGS. 3A and 3B). The snippet analyzer and indexer 31 then generates metadata from this semantic analysis, and finally stores the DJ snippet in a repository such as snippet database (DB) 32 and indexes the DJ snippet using the generated metadata for fast retrieval.

A snippet search service 34 performs the search function depicted in FIG. 4. More specifically, the snippet search service 34 receives a snippet request comprising current media (e.g., a song) information and metadata, the user profile, a preferences and context (e.g., location, time, etc.). The snippet search service 34 then searches the snippet database 32 (specifically, the metadata index of snippet database 32) using the received information and retrieves the most relevant snippets. The snippet search service 34 then returns the most relevant snippets, potentially after some post-processing (such as DRM-wrapping as at 35, re-encoding, late-binding or the like, as governed by the DRM and song/snippet/ad-matching rules as at 36).

The DJ snippet and ad server 30 also includes a snippet request/response interface 38 which is an interface for receiving snippet queries from client devices 50 of users 40 and thereafter responding with results, typically over a WAN or LAN network. In an exemplary embodiment, the snippet request/response interface 38 may be, for example, an HTTP server.

### EXAMPLE

In an example of the method according to the present invention, Bob the Blade talks about his Guns N' Roses concert experience: “I was there at November 2002 concert at Columbus Ohio. Axl Rose was great, the band flawless, the video presentation superb and the set list a definite crowd pleaser. Guitar solos usually bore me, but Buckethead treated the crowd to a variety of songs and musical styles, from funk to twangy banjosounding licks. Never have I heard a crowd sing along to a guitar solo—but tonight they did. Also showing a sense of humor, the solo went into ‘Old McDonald’ and the crowd responded with the E-I-E-I-O's. As the song played, Buckethead passed out things to the audience from two huge bags. It was like a twisted Santa moment.”

The snippet analysis and organization service analyzes the speech-to-text (or transcript of the commentary) and generates an exemplary snippet profile as shown below in XML format:

```
<commentary-segment>
    <snippet-id>DJ-1934:AE049x</snippet-id>
    <source-id>DJ-1934</source-id>
    <source-details>
        <name>Bob</name>
        <nick-name>Bob the Blade</nick-name>
        <sex>Male</sex>
        <voice>Gruff</voice>
    </source-details>
        <creation-timestamp>00DJ193984</creation-timestamp>
        <creation-location>Raleigh, NC</creation-location>
        <ownership>96rockonline.com</ownership>
        <rights-details>DRM-level-2</rights-details>
        <snippet-details>
            <duration>00:00:43</duration>
            <type>audio</type>
            <sponsorship>SP-ID-001034(“COKE”), SP-ID-
030215(“TACO”)</sponsorship>
        </snippet-details>
        <snippet-context>
            <media-reference>
                <media-reference-type>Category</media-reference-
type>
                <media-reference-value>Hard Rock</media-
reference-value>
            </media-reference>
            <media-reference>
                <media-reference-type>Artist</media-reference-
type>
                <media-reference-
value>”GNR”,“Buckethead”</media-reference-value>
            </media-reference>
            <media-reference>
                <media-reference-type>Instrument</media-
reference-type>
                <media-reference-value>Guitar</media-reference-
value>
        </media-reference>
        <media-reference>
            <media-reference-type>Styles</media-reference-type>
            <media-reference-value>Funk, Twang, Banjo</media-
reference-value>
        </media-reference>
        <location-reference>
            <location-reference-type>Concert</location-reference-type>
            <location-reference-date>November 2002</location-
reference-date>
            <location-reference-value>Columbus, OH</location-
reference-value>
        </location-reference>
        <snippet-tone>serious, admiring, complementary</snippet-tone>
        <keywords>solo, crowd, sing along, OI Mac Donald,
Santa</keywords>
    </snippet-context>
    <usability-constraints>
        <location-constraints>Global</location-constraints>
        <expiry-date>N/A</expiry-date>
    </usable-constraints>
</commentary-segment>
```

Listing 1. Example of a Snippet Profile in XML Format.

This profile is indexed using the metadata and contextual information and stored in a repository (e.g., snippet database 32).

At a later date, Joe (representing a user 40) is listening to music on his iPod® while driving to work. He has subscribed to the “On-Demand DJ Service”, and “November Rain” comes up. Such an “On demand DJ Service” provides DJ-like commentary for songs played locally on the user's 40 device. His device knows from his interests and past history that he is an avid concert-goer. He has also configured it to prefer male DJs because he feels they make the best Rock commentaries, and he prefers serious comments to sad attempts at humor. Hence, it prepares a snippet request with the media information, his context, preferences, as well as IDs of previously received snippets annotated with their play-through (or “success”) information ([Y]=played, [N]=skipped.) The exemplary request in XML format is shown below (note that “!=” means “not equal to”):

```
    <commentary-request>
        <media-keywords>November Rain, Guns N' Roses</media-
keywords>
        <user-context>”Car”, “Location:I-40”, “Location:Raleigh,
NC”</user-context>
        <user-interests>”jazz”, “Hard Rock”, “Concert”, “Guitar”</user-
interests>
        <user-preferences>”snippet.tone!=funny”, “source.sex!=Female”
</user-preferences>
        <recent-snippet-ids>DJ-0034:1E059x[Y], DJ-1904:x0594A[N],
DJ-2822:0a023Z[Y], DJ-1934:0394x [N], DJ-1934:9475z[Y],
DJ-934A:03E41[Y], DJ-6232:28031[Y]</recent-snippet-ids>
    </commentary-request>
```

Listing 2. Example of a Snippet Request in XML Format.

The search service receives this request and searches the repository using the media keywords, user interests and user context against the indexed metadata and snippet contexts. The request of listing 2 hence returns the profile of listing 1, which is used to retrieve the appropriate snippet to forward to Joe.

In another example, people at the Wal-mart in Columbus, Ohio, get to subscribe to Wal-mart's “WM.FM” LBS Internet radio. The playlist strategy brings up “Civil War”. The near-real-time DJ service generates a request for all its users, and since it is for a large collection of users, personal preferences and interests are either not included, or aggregated to find the statistically most common interests. In the exemplary request XML of Listing 3, only the location context is included, since that is common for all users:

```
    commentary-request>
        <media-keywords>Civil War, Guns N' Roses</media-
        keywords>
        <user-context>”Shopping”, ”Wal-mart”, “Location:Columbus,
OH”</user-context>
        <recent-snippet-ids>DJ-0034:1E059x[Y], DJ-1904:x0594A[N],
DJ-2822:0a023Z[Y], DJ-1934:0394x [N], DJ-1934:9475z[Y],
DJ-934A:03E41[Y], DJ-6232:28031[Y]</recent-snippet-ids>
    </commentary-request>
```

Listing 3. Example of a Snippet Request in XML Format.

Since the current user location is in Columbus, Ohio, it has a strong contextual relation to the snippet with the profile of Listing 1 via the user-context/location field in the request and the snippet-context/location reference field in the profile. Hence, that snippet is returned and inserted into the WM.FM radio stream.

The present invention has substantial opportunity for variation without departing from the spirit or scope of the present invention. For example, while the embodiments discussed herein are directed to DJ media snippet content profiles generated in XML format, the present invention is not limited thereto.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of generating metadata for disc jockey (DJ) commentary media segments to enable contextually relevant searches, the method comprising:
generating data including using at least one of speech-to-text conversion or audio/video analysis;
analyzing the generated data to extract subject matters;
filtering the extracted subject matters such that they only refer to a pre-determined set of subjects;
accepting any other contextual information;
generating metadata tags for each of the media segments using the predetermined set of subjects referenced during the filtering step;
generating a context profile for each of the media segments using the metadata tags and the other contextual information; and
indexing the media segments using at least one of the metadata tags or the context profile.

2. The method of claim 1, wherein the predetermined set of subjects of the filtering step includes at least one of: media content, artist or category, events and conditions, time, location, or opinions.

3. The method of claim 1, further comprising:
receiving user context information, including time, location and interests;
building a context profile from the received user context information in the same format as the metadata tag generating step;
finding one or more commentary media segments by searching the index constructed by the metadata tag generating step using a profile of the extracted subject matters of the analyzing step; and
identifying a most relevant commentary media segment by determining that the most relevant commentary media segment's profile most matches the profile of the analyzing step.

4. The method of claim 1, wherein prior to the analyzing step, further comprising assigning a tone to the media segment based on at least one of voice-recognition or laughter detection.

5. The method of claim 1, wherein prior to the analyzing step, further comprising categorizing a voice of the media segment.

6. The method of claim 1, wherein the extracted subject matters of the analyzing step are selected from at least one of semantic analysis, keyword analysis, or natural language processing.

7. The method of claim 1, wherein the context profile is in an extensible markup language (XML) format.

8. The method of claim 1, further comprising discarding media segments that are unsuitable for re-use by checking if their context is too narrow.

9. The method of claim 8, wherein in the step of discarding media segments, the context checking is carried out using at least one of heuristics, keyword filtering using pre-configured keywords, pre-configured rules that operate on the metadata tags.

10. The method of claim 3, wherein after identifying the most relevant commentary media segment, presenting the most relevant commentary media segment to a user's mobile device.

11. The method of claim 1, wherein the step of generating data includes using both textual data and speech data.

12. The method of claim 1, further comprising:
receiving user context information, including time, location and interests;
finding one or more commentary media segments by searching the index constructed by the indexing step;
identifying a most relevant commentary media segment by determining that the most relevant commentary media segment's profile matches most closely to the context profile of the indexing step; and
presenting the most relevant commentary media segment to a user's mobile device.

13. A system for generating metadata for disc jockey (DJ) commentary media segments to enable contextually relevant searches, comprising:
means for generating data including using at least one of speech-to-text conversion or audio/video analysis;
means for analyzing the generated data to extract subject matters;
means for filtering the extracted subject matters such that they only refer to a pre-determined set of subjects;
means for accepting any other contextual information;
means for generating metadata tags for each of the media segments using the predetermined set of subjects referenced by the filtering means;
means for generating a context profile for each of the media segments using the metadata tags and the other contextual information; and
means for indexing the media segments using at least one of the metadata tags or the context profile.

14. The system of claim 13, wherein the predetermined set of subjects of the filtering means includes at least one of: media content, artist or category, events and conditions, time, location, or opinions.

15. The system of claim 13, further comprising:
means for receiving user context information, including time, location and interests;
means for building a context profile from the received user context information in the same format as the metadata tag generation;
means for finding one or more commentary media segments by searching the index constructed by the metadata tag generation using a profile of the extracted subject matters of the analyzing means; and
means for identifying a most relevant commentary media segment by determining that the most relevant commentary media segment's profile most matches the profile of the analyzing means.

16. The system of claim 13, wherein prior to the analysis of the analyzing means, further comprising means for assigning a tone to the media segment based on at least one of voice-recognition or laughter detection.

17. The system of claim 13, wherein prior to the analysis of the analyzing means, further comprising means for categorizing a voice of the media segment.

18. The system of claim 13, wherein the extracted subject matters of the analyzing means are selected from at least one of semantic analysis, keyword analysis, or natural language processing.

19. The system of claim 13, wherein the context profile is in an extensible markup language (XML) format.

20. The system of claim 13, further comprising means for discarding media segments that are unsuitable for re-use by checking if their context is too narrow.

21. The system of claim 20, wherein the discarding means carries out the context checking using at least one of heuristics, keyword filtering using pre-configured keywords, pre-configured rules that operate on the metadata tags.

22. The system of claim 15, wherein after the means for identifying has identified the most relevant media segment, the system further comprises means for presenting the most relevant commentary media segment to a user's mobile device.

23. The system of claim 13, wherein the means for generating data includes using both textual data and speech data.

24. A computer readable medium comprising a program for instructing a system to:
generate data including using at least one of speech-to-text conversion or audio/video analysis;
analyze the generated data to extract subject matters;
filter the extracted subject matters such that they only refer to a pre-determined set of subjects;
accept any other contextual information;
generate metadata tags for each of the media segments using the predetermined set of subjects referenced during the filtering operation;
generate a context profile for each of the media segments using the metadata tags and the other contextual information; and
index the media segments using at least one of the metadata tags or the context profile.

25. The computer readable medium of claim 24, wherein the predetermined set of subjects of the filtering operation includes at least one of: media content, artist or category, events and conditions, time, location, or opinions.

26. The computer readable medium of claim 24, wherein the program further instructs the system to:
receive user context information, including time, location and interests;
build a context profile from the received user context information in the same format as the metadata tag generation;
find one or more commentary media segments by searching the index constructed by the metadata tag generation using a profile of the extracted subject matters of the analysis operation; and
identify a most relevant commentary media segment by determining that the most relevant commentary media segment's profile most matches the profile of the analysis operation.

27. The computer readable medium of claim 24, wherein prior to the analysis operation, the program is further operative to instruct the system to assign a tone to the media segment based on at least one of voice-recognition or laughter detection.

28. The computer readable medium of claim 24, wherein prior to the analysis operation, the program is further operative to instruct the system to categorize a voice of the media segment.

29. The computer readable medium of claim 24, wherein the extracted subject matters of the analysis operation are selected from at least one of semantic analysis, keyword analysis, or natural language processing.

30. The computer readable medium of claim 24, wherein the context profile is in an extensible markup language (XML) format.

31. The computer readable medium of claim 24, wherein the program is further operative to instruct the system to discard media segments that are unsuitable for re-use by checking if their context is too narrow.

32. The computer readable medium of claim 31, wherein in the operation of discarding media segments, the context checking is carried out using at least one of heuristics, keyword filtering using pre-configured keywords, pre-configured rules that operate on the metadata tags.

33. The computer readable medium of claim 26, wherein after the operation of identifying the most relevant media segment, the program instructs the system to present the most relevant commentary media segment to a user's mobile device.

34. The computer readable medium of claim 24, wherein the operation of generating data includes using both textual data and speech data.

35. The computer readable medium of claim 24, wherein the program further instructs the system to:
receive user context information, including time, location and interests;
find one or more commentary media segments by searching the index constructed by the indexing operation;
identify a most relevant commentary media segment by determining that the most relevant commentary media segment's profile matches most closely to the context profile of the indexing operation; and
present the most relevant commentary media segment to a user's mobile device.
